(19) United States
(12) Patent Application Publication
(10) Pub. No.: US 2023/0343491 A1
(43) Pub. Date: Oct. 26, 2023

(54) IGNITION RESISTOR AND MANUFACTURING METHOD THEREOF

(71) Applicant: VIKING TECH CORPORATION, Hsinchu County (TW)

(72) Inventors: WIE-LIN CHIANG, Hsinchu County (TW); CHENG-CHUNG CHIU, Hsinchu County (TW); SHUN-HO KUO, Hsinchu County (TW); CHI-YU LU, Hsinchu County (TW)

(21) Appl. No.: 18/304,926

(22) Filed: Apr. 21, 2023

(30) Foreign Application Priority Data
Apr. 25, 2022 (TW) 111115651

(51) Int. Cl. H01C 1/032; H01C 1/14; H01C 1/024

(52) U.S. Cl. CPC H01C 1/032; H01C 1/14; H01C 1/024

(57) ABSTRACT

An ignition resistor comprises a substrate, two antistatic layers, an ignition structure and a protective layer. The ignition structure is attached to the upper surface of the substrate through an adhesive layer, wherein the ignition structure includes two electrode portions and an ignition portion, the two electrode portions are respectively connected to two opposite ends of the ignition portion. The two antistatic layers are respectively disposed on the opposite sides of the ignition portion and the upper surface of the substrate between the two electrode portions, and the protective layer covers the ignition portion.

### BACKGROUND OF THE INVENTION

### 1. Field of the Invention

The present invention relates to an ignition resistor, in particular to an ignition resistor with high humidity-resistance and anti-static characteristic.

### 2. Description of the Prior Art

Generally, the surface resistance igniter is a narrow channel with low resistance. When a high voltage is applied, the narrow channel fuses and sparks to turn the electric energy into thermal energy in a short time, i.e. fused ignition.

Generally, the resistance value of the narrow channels of the surface resistance ignitor requires to be accurate. However, as the narrow channels are easy to contact with external vapor or sulfur gas and generate unwilling chemical reactions, the narrow channels are vulnerable to static electricity in the environment, causing ineffectiveness of the ignition of the ignition resistor.

### SUMMARY OF THE INVENTION

In order to solve the above-mentioned problems, a layer of highly moisture-resistant protective gels is used to cover the ignition circuit, and conductive layers are disposed on both sides of the ignition circuit. That leads to eliminate static electricity and to improve the anti-moisture and antistatic capabilities of an ignition resistor.

The present invention provides an ignition resistor, comprising:
an ignition structure, which comprises an ignition portion and two electrode portions connected with both ends of the ignition portion, and an adhesive layer is used to stick the ignition structure on a substrate;
two anti-static layers, disposed on the substrate both sides of the ignition portion between the two electrode portions; and
a protective layer, covering the ignition portion.

The present invention provides a manufacturing method of an ignition resistor, comprising:
sticking an ignition structure on a substrate with an adhesive layer, wherein the ignition structure comprises an ignition portion and two electrode portions connected both ends of the ignition portion;
forming two anti-static layers on the substrate and both sides of the ignition portion and between the two electrode portions; and
covering the ignition portion by a protective layer.

### BRIEF DESCRIPTION OF THE DRAWINGS

FIG. 1 shows a top view of the ignition resistor of the present invention.

FIG. 2 is a cross section diagram of FIG. 1 with A-A′ Cut line.

FIG. 3 is a side view of the ignition resistor of the present invention.

### DESCRIPTION OF THE PREFERRED EMBODIMENTS

Various embodiments of the present invention will be described in detail as below, and the drawings will be used as examples to help readers to have a better understanding. In addition to these detailed descriptions, the present invention can also be widely implemented in other embodiments. Any substitutions, modifications, and equivalent changes of the embodiments should be understood to be included in the scope of the present invention. The scope of patents should be based on the scope of the claims. It should be noted that the drawings are for illustrative purposes only, and do not represent the actual size or quantity of the components. Some details may not be completely drawn in order to keep the drawings concise.

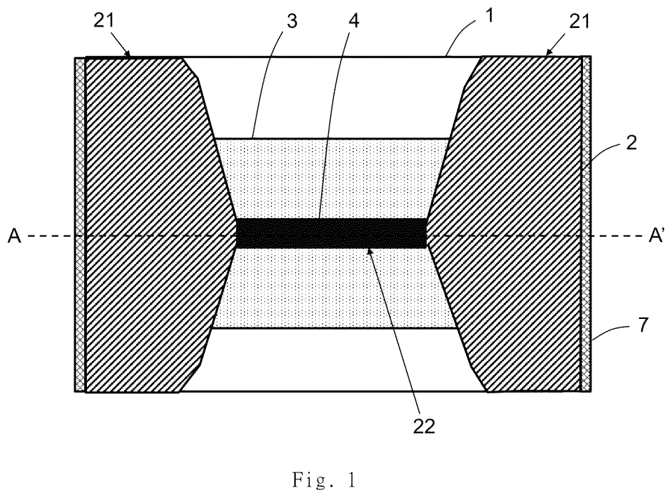

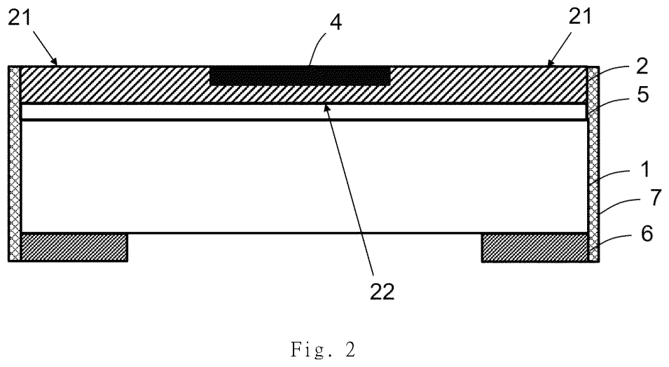

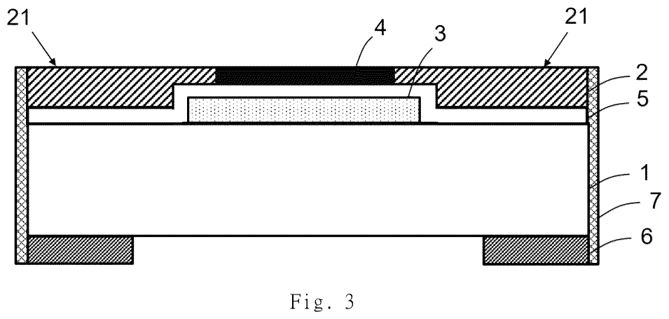

FIG. 1 to FIG. 3 disclose a top view, a cut line section view and a side view of an ignition resistor of the present invention. The ignition resistor of the present invention includes a substrate 1, two anti-static layers 3, an ignition structure 2, and a protective layer 4. The ignition structure 2 is disposed on the upper surface of the substrate 1. An adhesive layer 5 sticks the ignition structure 2 on the substrate. The ignition structure 2 comprises an ignition portion 22 (narrow part) and two electrode portions 21 (wide part both ends) connected both ends of the ignition portion 22. The two antistatic layers 3 are respectively disposed on the substrate 1, opposite sides of the ignition portion 22 and between the two electrode portions 21. In particular, the adhesive layer 5 in an embodiment of the present invention is transparent and colorless. The adhesive layer 5 can also be coated on the two anti-static layers 3. Therefore, the two anti-static layers 3 can be seen directly from the top view shown by FIG. 1.

In some embodiments, the ignition resistor further comprises two rear electrodes 6 disposed on the rear surface of the substrate 1. Both rear electrodes 6 correspond to both electrode portions 21 and electrically connect to both electrode portions 21 by conductive layers 7 disposed on the two sides of the substrate 1. In this embodiment, the ignition resistor can connect with the external circuit board via the rear electrodes 6. When conducting, the current can enter from one of the rear electrodes 6, pass through one of the conductive layers 7, one of the electrode portions 21, the ignition portion 22, the other electrode portion 21, the other side conductive layer, and flows out from the other rear electrode. The ignition portion 22 generates heat and sparks.

In a preferred embodiment, the ignition portion 22 is thinner and narrower than electrode portion 21. The ignition structure 2 has an I-shape from top view, the narrow channel is the ignition portion 22, and both wide ends are the two electrode portions 21. The width of ignition portion 22 is in the range of 40-100 μm.

In an embodiment, the thickness of the protective layer 4 and the thickness of the ignition portion 22 are 8 to 15 μm. In one embodiment, the protective layer 4 and the thickness of the ignition portion 22 have the same thickness. The protective layer 4 isolates the ignition portion 22 from external moisture or sulfur gas. When a voltage is applied, the temperature of the ignition portion 22 can reach 280° C. above, i.e. the ignition portion 22 is transformed to be a hot spot. It means the heat resistibility of the protective layer is also above 280° C.

In a preferred embodiment, the material of the ignition structure 2 is nickel-chromium alloy, copper-nickel alloy or copper. The material of the substrate 1 is polyimide, polycarbonate, glass fiber or ceramic material. The material of the antistatic layer 3 is copper. The material of protective layer 4 is epoxy resin.

The manufacturing method of ignition resistor of the present invention comprises:

Step 1: sticking an ignition structure on a substrate through an adhesive layer, wherein the ignition structure comprises an ignition portion and two electrode portions connected to both ends of the ignition portion;

Step 2: forming two anti-static layers on the substrate both sides of the ignition portion between the two electrode portions; and

Step 3: covering the ignition portion by a protective layer.

In some embodiments, the adhesive layer can be coated on the two antistatic layers.

In some embodiments, the manufacturing method of ignition resistor further comprises forming a rear electrode on rear surface of the substrate corresponding to both electrodes, and forming two side conductive layers for connecting the two electrode portions with the two rear portions.

The ignition resistor of the present invention improves the moisture resistance and antistatic ability by covering the ignition circuit with a layer of moisture-resistant protective gels and disposing antistatic layers on both sides of the ignition circuit.

1. An ignition resistor, comprising:
an ignition structure, wherein the ignition structure comprises an ignition portion and two electrode portions connected to both ends of the ignition portion, and an adhesive layer is used to adhere the ignition structure on a substrate; and
two anti-static layers, disposed on the substrate on both sides of the ignition portion between the two electrode.

2. The ignition resistor according to claim 1, further comprising two rear electrodes, on rear of the substrate corresponding to the two electrode portions, and two side conductive layers, on side surface of the substrate and each for connecting one electrode portion with one read electrode.

3. The ignition resistor according to claim 1, wherein the ignition portion is thinner than the electrode portion.

4. The ignition resistor according to claim 1, wherein the thickness of the protective layer and the ignition portion are 8 to 15 μm.

5. The ignition resistor according to claim 1, the electrode portion is wider than the ignition portion.

6. The ignition resistor according to claim 1, wherein the material of the two anti-static layer is copper.

7. The ignition resistor according to claim 1, wherein the material of the protective layer is epoxy resin.

8. A manufacturing method of an ignition resistor, comprising:
sticking an ignition structure on a substrate by an adhesive layer, wherein the ignition structure comprises an ignition portion and two electrode portions connected to both ends of the ignition portion; and
forming two anti-static layers on the substrate on both sides of the ignition portion between the two electrode portions.

9. The manufacturing method of an ignition resistor according to claim 8, further comprising:
covering the ignition portion by a protective layer;
forming two rear electrodes on rear of the substrate corresponding to the two electrode portions; and
forming two side conductive layers for connecting the two electrode portions with the two rear electrodes.

10. The ignition resistor according to claim 1, further comprises a protective layer, covering the ignition portion.
